(19) United States
(12) Patent Application Publication
(10) Pub. No.: US 2022/0180244 A1
(43) Pub. Date: Jun. 9, 2022

(54) Inter-Feature Influence in Unlabeled Datasets

(71) Applicant: VMware, Inc., Palo Alto, CA (US)

(72) Inventors: Yaniv Ben-Itzhak, Afek (IL); Shay Vargaftik, Nazareth-Illit (IL)

(21) Appl. No.: 17/115,432

(22) Filed: Dec. 8, 2020

(51) Int. Cl. G06N 20/00; G06F 16/23; G06N 5/04

(52) U.S. Cl. CPC G06N 20/00; G06N 5/04; G06F 16/2365

(57) ABSTRACT

In one set of embodiments, a computer system can receive an unlabeled dataset comprising a plurality of unlabeled data instances, each unlabeled data instance including values for a plurality of features. The computer system can train, for each feature, a supervised machine learning (ML) model on a labeled dataset derived from the unlabeled dataset, where the labeled dataset comprises a plurality of labeled data instances, and wherein each labeled data instance includes (1) a label corresponding to a value for the feature in an unlabeled data instance of the unlabeled dataset, and (2) values for other features in the unlabeled data instance. The computer system can then compute, for each pair of first and second features in the plurality of features, an inter-feature influence score using the trained supervised ML model for the second feature, the inter-feature influence score indicating how useful the first feature is in predicting the second feature.

### BACKGROUND

In machine learning (ML), there are two main types of learning approaches: supervised and unsupervised. Supervised learning involves training a supervised ML model on a labeled dataset comprising labeled data instances. Each labeled data instance includes values for the features (i.e., attributes/dimensions) of the dataset and a label, typically determined by a human, indicating the correct value that should be output/predicted by the supervised ML model upon being provided the data instance's feature values as inputs. This label can be a class/category in the case where the ML task is classification or a continuous number in the case where the ML task is regression. By training the supervised ML model in this manner, the supervised ML model can learn how the feature values of the labeled dataset's data instances map to their desired outputs/predictions. Once the training is complete, the supervised ML model can be applied to generate predictions for query data instances (i.e., data instances whose labels are unknown).

Unsupervised learning, on the other hand, does not make use of a labeled dataset and does not involve training a supervised ML model. Instead, with unsupervised learning, an unsupervised ML model is provided as input an unlabeled dataset comprising unlabeled data instances (i.e., data instances that do not have labels indicating what their correct outputs/predictions should be). The unsupervised ML model then makes inferences—or in other words, generates predictions—regarding the unlabeled data instances based on information gleaned from the inherent structure of that data. For example, one common type of unsupervised ML model is a clustering model that groups unlabeled data instances into clusters according to the data distribution of the unlabeled dataset.

In the context of supervised learning, it is possible to compute feature importance scores for the features in a labeled dataset L used to train a supervised ML model M, where the feature importance score for a given feature f in L signifies the importance or usefulness of f in generating correct predictions via the trained version of M. Upon computing these feature importance scores, they can be leveraged in various ways to improve the efficiency and effectiveness of the supervised learning process.

However, in the context of unsupervised learning, there is no analogous technique for calculating feature importance scores for the features in an unlabeled dataset, because such a dataset does not include labels and thus lacks a “ground truth” for determining the predictive importance/usefulness of each feature. As a result, there is currently no way to improve the efficiency and effectiveness of unsupervised learning using a feature-based metric that is similar to the feature importance metric available in supervised learning.

### BRIEF DESCRIPTION OF THE DRAWINGS

FIG. 1 depicts an example computer system and high-level process according to certain embodiments.

FIG. 2 depicts a flowchart for computing inter-feature influence scores according to certain embodiments.

FIG. 3 depicts a flowchart for performing dimensionality reduction using inter-feature influence scores according to certain embodiments.

FIGS. 4A and 4B depict example graphs created as part of the flowchart of FIG. 3 according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

The present disclosure is directed to techniques for computing and using a new type of feature-based metric, referred to herein as “inter-feature influence,” for the features (e.g., f₁, . . . , fₙ) in an unlabeled dataset X. Generally speaking, these techniques involve training a set of supervised ML models M₁, . . . , Mₙ on labeled datasets that are derived from unlabeled dataset X, such that each supervised ML model Mᵢ is trained to predict feature fᵢ based on the other features in X. The techniques further involve computing an inter-feature influence score for each pair of features in X using the trained versions of supervised ML models M₁, . . . , Mₙ, where the inter-feature influence score for a given feature pair (fᵢ, fⱼ) indicates the degree of influence feature fᵢ has on feature fⱼ (or in other words, how useful/important feature fᵢ is in predicting feature fⱼ).

With these techniques, the inter-feature influence scores computed for unlabeled dataset X can be leveraged in various ways that are similar to the use cases for feature importance scores in supervised learning. For example, in certain embodiments the inter-feature influence scores can be applied to perform dimensionality reduction on unlabeled dataset X, which means reducing the number of features (i.e., dimensions) in X from n to some lower number n−r. Among other things, this advantageously allows unlabeled dataset X to be used, in its compressed/reduced form, for unsupervised learning in environments that that cannot efficiently operate on high dimensional datasets due to compute, memory, bandwidth, time, and/or other constraints.

The foregoing and other aspects of the present disclosure are described in further detail in the sections that follow.

### 2. High-Level Process

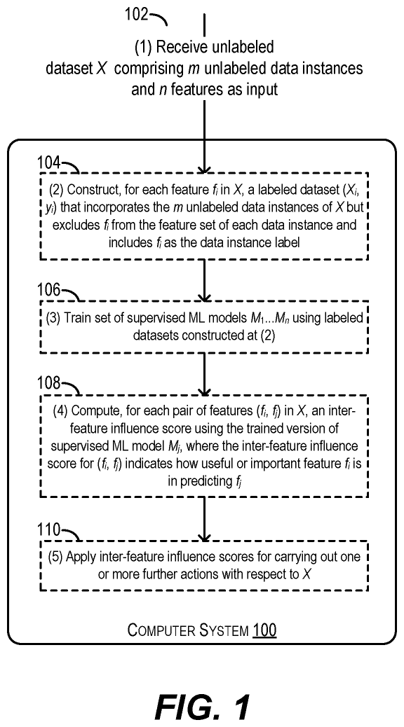

FIG. 1 depicts a computer system 100 and a high-level process (comprising steps (1)-(5)/reference numerals 102-110) that may be executed by computer system 100 for implementing the techniques of the present disclosure according to certain embodiments.

Starting with step (1) (reference numeral 102), computer system 100 can receive an unlabeled dataset X that is composed of m unlabeled data instances d₁, . . . , dₘ and n features f₁, . . . , fₙ. Each unlabeled data instance dᵢ can be understood as a row of unlabeled dataset X and each feature fᵢ can be understood as a column or dimension of X, such that each unlabeled data instance includes n feature values corresponding to features f₁, . . . , fₙ. By way of example, Table 1 below illustrates a version of unlabeled dataset X in the scenario where X comprises three features (columns) “age,” “eye color,” and “hair color” and four unlabeled data instances (rows) with values for these features:

TABLE 1
Example Unlabeled Dataset X

| Age | Hair Color | Eye Color |
|---|---|---|
| 25 | Black | Brown |
| 63 | Gray | Blue |
| 16 | Brown | Brown |
| 52 | Gray | Green |

At step (2) (reference numeral 104), computer system 100 can construct, for each feature fᵢ of unlabeled dataset X, a labeled dataset (Xᵢ, yᵢ) that incorporates the m unlabeled data instances of X, but (a) excludes feature fᵢ from the feature set of each data instance in (Xᵢ, yᵢ) and (b) adds fᵢ as the dataset's label column (i.e., y) (resulting in labeled, rather than unlabeled, data instances). Stated in a more formal manner, each labeled dataset constructed at step (2) can be defined as follows:

$$( {X}_{i} , {y}_{i} ) = \{ \begin{matrix}{X}_{i} = X \backslash X [ i ] \\ {y}_{i} = X [ i ]\end{matrix} \\ for i ∈ [ 1 … n ] \qquad Listing 1$$

In the formulation above, X[i] is the i'th feature of unlabeled dataset X, Xᵢ is the matrix of features in labeled dataset (Xᵢ, yᵢ), and yᵢ is the column (or vector) of labels in labeled dataset (Xᵢ, yᵢ). In addition, the expression “a\b” indicates that b is excluded from a (and thus “X\ X[i]” signifies the exclusion of feature i from unlabeled dataset X).

Assuming the foregoing formulation is applied to the version of unlabeled dataset X shown in Table 1, the following are the labeled datasets that would be created for the features “age,” “hair color,” and “eye color” respectively:

TABLE 2
Labeled Dataset for Feature “Age”

| Hair Color | Eye Color | Label |
|---|---|---|
| Black | Brown | 25 |
| Gray | Blue | 63 |
| Brown | Brown | 16 |
| Gray | Green | 52 |

TABLE 3
Labeled Dataset for Feature “Hair Color”

| Age | Eye Color | Label |
|---|---|---|
| 25 | Brown | Black |
| 63 | Blue | Gray |
| 16 | Brown | Brown |
| 52 | Green | Gray |

TABLE 4
Labeled Dataset for Feature “Eye Color”

| Age | Hair Color | Label |
|---|---|---|
| 25 | Black | Brown |
| 63 | Gray | Blue |
| 16 | Brown | Brown |
| 52 | Gray | Green |

Upon constructing the labeled datasets using unlabeled dataset X at step (2), computer system 100 can train a corresponding set of supervised ML models M₁, . . . , Mₙ on those labeled datasets (step (3); reference numeral 106). Through this training, each supervised ML model Mᵢ can be trained to predict the value of feature fᵢ in unlabeled dataset X based on the values of the other features in X. For example, with respect to the version of unlabeled dataset X in Table 1, computer system 100 would train a first supervised ML model M₁ on the labeled dataset shown in Table 2 (thereby training M₁ to predict “age” based on the values for “hair color” and “eye color”); train a second supervised ML model M₂ using the labeled dataset shown in Table 3 (thereby training M₂ to predict “hair color” based on values for “age” and “eye color”); and train a third supervised ML model M₃ using the labeled dataset shown in Table 4 (thereby training M₃ to predict “eye color” based on values for “age” and “hair color”).

In this scenario, because “age” is a numerical feature, supervised ML model M₁ will be a regressor model (i.e., an ML model configured to predict/output a numerical value). In contrast, because “hair color” and “eye color” are categorical features, supervised ML models M₂ and M₃ will be classifier models (i.e., ML models configured to predict/output categorical, or class, values).

Once the ML model training at step (3) is complete, computer system 100 can compute, for each pair of features (fᵢ, fⱼ) in unlabeled dataset X, an inter-feature influence score using the trained version of supervised ML model Mⱼ, where the inter-feature influence score for feature pair (fᵢ, fⱼ) indicates how useful or important fᵢ is in predicting fⱼ (step (4); reference numeral 108). For example, with respect to the version of unlabeled dataset X in Table 1, computer system 100 would compute inter-feature influence scores for: (1) feature pair (“age,” “hair color”) using the trained version of the supervised ML model for “hair color,” (2) feature pair (“age,” “eye color”) using the trained version of the supervised ML model for “eye color,” (3) feature pair (“hair color,” “age”) using the trained version of the supervised ML model for “age,” (4) feature pair (“hair color,” “eye color”) using the trained version of the supervised ML model for “eye color,” (5) feature pair (“eye color,” “age”) using the trained version of the supervised ML model for “age,” and (6) feature pair (“eye color,” “hair color”) using the trained version of the supervised ML model for “hair color.”

In one set of embodiments, the computation of the inter-feature influence score for each feature pair (fᵢ, fⱼ) can be carried out using a “random re-shuffling” approach that involves determining a first accuracy score for the trained version of supervised ML model Mⱼ, randomly re-shuffling the values for feature fᵢ in labeled dataset (Xⱼ, yⱼ) (resulting in a new labeled dataset (Xⱼ, yⱼ)′), re-training Mⱼ on new labeled dataset (Xⱼ, yⱼ)′, determining a second accuracy score for the re-trained version of Mⱼ, and computing the inter-feature influence score based on the first and second accuracy scores. This approach is described in further detail in Section (3) below. In other embodiments, the inter-feature influence score computation at step (4) can be carried out using other approaches that are similar to existing techniques for computing feature importance scores in supervised learning. This is possible because the inter-feature influence score for feature pair (fᵢ, fⱼ) is analogous to the feature importance score for feature fᵢ in the context of labeled dataset (Xⱼ, yⱼ).

Finally, at step (5) (reference numeral 110), computer system 100 can apply the inter-feature influence scores computed at step (4) in order to carry out one or more further actions with respect to unlabeled dataset X. As one example, computer system 100 can provide the inter-feature influence scores as additional input features to one or more unsupervised ML models that operate on unlabeled dataset X. As another example, computer system 100 can use the inter-feature influence scores to reduce the number of features/dimensions in unlabeled dataset X and thereby compress it, without substantially affecting the dataset's inherent structure and data distribution. One method for implementing this dimensionality reduction is detailed in Section (4) below.

It should be appreciated that FIG. 1 is illustrative and not intended to limit embodiments of the present disclosure. For example, although the process shown in FIG. 1 is assumed to run on a single computer system (i.e., computer system 100), in some embodiments this process may be executed in a distributed fashion across multiple computer systems/devices for enhanced performance, reliability, fault tolerance, or other reasons. One of ordinary skill in the art will recognize other variations, modifications, and alternatives.

### 3. Inter-Feature Influence Score Computation

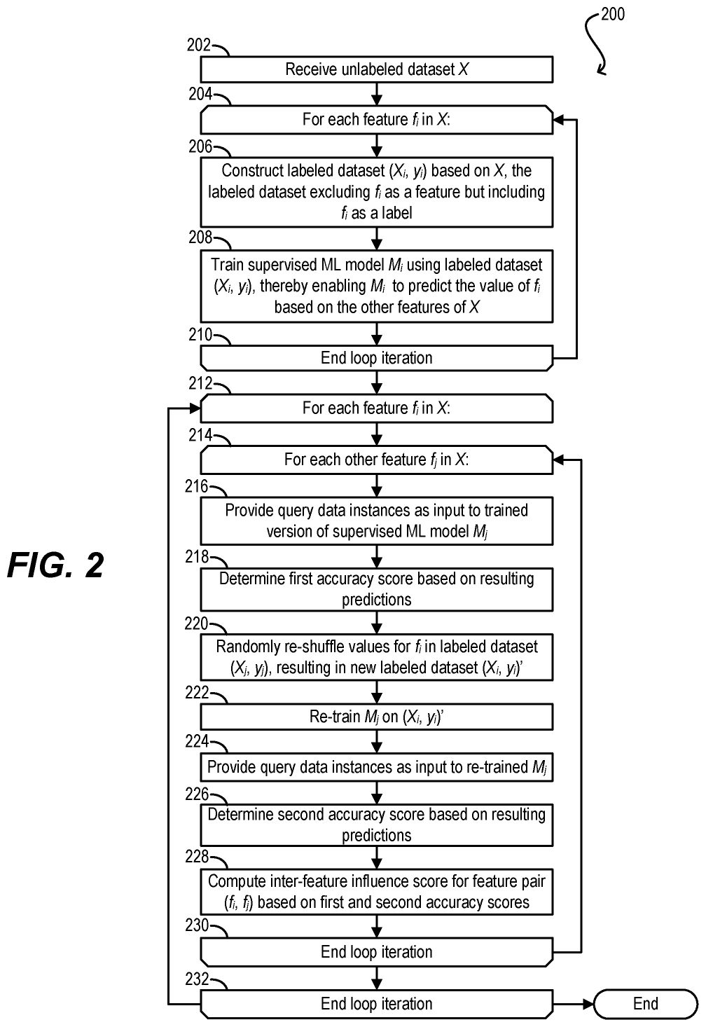

FIG. 2 depicts a flowchart 200 that provides additional details regarding the processing that may be performed by computer system 100 for computing inter-feature influence scores for the features of unlabeled dataset X, per steps (1)-(4) of FIG. 1, according to certain embodiments. Flowchart 200 assumes that computer system 100 implements a random re-shuffling approach in order to compute the inter-feature influence score for each pair of features (fᵢ, fⱼ).

Starting with blocks 202 and 204, computer system 100 can receive unlabeled dataset X (comprising unlabeled data instances d₁, . . . , dₘ and features f₁, . . . , fₙ as mentioned above) and enter a first loop for each feature fᵢ in X (where i=1, . . . , n).

Within this first loop, computer system 100 can construct a labeled dataset (Xᵢ, yᵢ) that incorporates the m unlabeled data instances in unlabeled dataset X, but excludes feature fᵢ from each data instance and instead adds that feature as the label for the data instance (block 206). Computer system 100 can then train a supervised ML model Mᵢ using labeled dataset (Xᵢ, yᵢ) (block 208), thereby enabling model Mᵢ to predict the value of feature fᵢ based on the values of features f₁, . . . , fₙ\fᵢ (i.e., the features of unlabeled dataset X excluding fᵢ).

As noted previously, in scenarios where feature fᵢ is categorical, model M₁ will be a classifier model; conversely, in scenarios where feature fᵢ is numerical, model M₁ will be a regressor model. However, computer system 100 is not otherwise constrained in terms of the type of ML model that it uses to implement Mᵢ. For example, if feature fᵢ is categorical, M₁ may be implemented using a random forest classifier, an adaptive boosting classifier, a gradient booster classifier, etc. Similarly, if feature fᵢ is numerical, Mᵢ may be implemented using a random forest regressor, an adaptive boosting regressor, and so on. In certain embodiments, computer system 100 may employ different types of classifier/regressor models for different features of X (e.g., a random forest classifier for feature f₁, an adaptive boosting classifier for feature f₂, etc.).

Upon training supervised ML model M₁ at block 208, computer system 100 can reach the end of the current loop iteration (block 210) and return to the top of the loop to process the next feature. Once all of the features have been processed and corresponding supervised ML models M₁, . . . , Mₙ have been trained, computer system 100 can enter a second loop for each feature fᵢ in X (block 212) and, within this second loop, enter a third loop for each feature fⱼ in X that is not fᵢ (in other words, the set of features in X that exclude fᵢ) (block 214).

Within this third loop, computer system 100 can compute the inter-feature influence score for feature pair (fᵢ, fⱼ) using the random re-shuffling approach mentioned earlier. In particular, at blocks 216 and 218, computer system 100 can provide one or more query data instances as input to the trained version of supervised ML model Mⱼ and determine a first accuracy score for the trained version of Mⱼ based on the resulting predictions. In a particular embodiment, this accuracy score can be computed as the number of correct predictions made by Mⱼ divided by the total number of predictions.

At block 220, computer system 100 can randomly re-shuffle the values for feature fᵢ in labeled dataset (Xⱼ, yⱼ)—such that the values in the column of (Xⱼ,yⱼ) corresponding to fᵢ are randomly switched among the labeled data instances of (Xⱼ, yⱼ)—resulting in a new labeled dataset (Xⱼ, yⱼ)′. Computer system 100 can thereafter re-train supervised ML model Mⱼ using (Xⱼ, yⱼ)′ (block 222), provide the same query data instances from block 216 as input to the re-trained version of supervised ML model Mⱼ (block 224), and determine a second accuracy score for the re-trained version of Mⱼ based on the resulting predictions (block 226).

Then, at block 228, computer system 100 can compute an inter-feature influence score for feature pair (fᵢ, fⱼ) based on the first and second accuracy scores determined at blocks 218 and 226 respectively. In a particular embodiment, the computed inter-feature influence score can be proportional to the degree of divergence between the first and second accuracy scores, such that a relatively high degree of divergence between the two accuracy scores corresponds to a relatively high inter-feature influence score and a relatively low degree of divergence between the two accuracy scores corresponds to a relatively low inter-feature influence score. This is because a high degree of divergence indicates that feature fᵢ has a strong influence on predicting feature fⱼ and conversely a low degree of divergence indicates that feature fᵢ does not have a strong influence on predicting feature fⱼ.

Upon computing the inter-feature influence score at block 228, computer system 100 can reach the end of the current loop iteration for feature fⱼ (block 230) and return to block 214 in order to process the next fⱼ in X that is not fᵢ. Further, upon processing all of the features in X that are not fᵢ, computer system 100 can reach the end of the current loop iteration for feature fᵢ (block 232) and return to block 212 in order to process the next fᵢ in X. Finally, upon processing all of the features in X per blocks 212-232, the flowchart can end.

It should be appreciated that flowchart 200 is illustrative and various modifications are possible. For example, although flowchart 200 assumes that computer system 100 creates and trains n separate supervised ML models (one for each feature f₁, . . . , fₙ) via the first loop starting at block 204, in some embodiments computer system 100 may create and train less than n models by, e.g., selecting a subset of features for model creation/training (using principal component analysis (PCA) or some other feature selection/ranking method) or by combining several features into a single feature (via a sum, sum of squares, or any other function).

Further, although flowchart 200 assumes that the labeled dataset (Xᵢ, yᵢ) constructed for each feature fᵢ at block 206 includes all of the features of unlabeled dataset X other than fᵢ (i.e., features f₁, . . . , fₙ\fᵢ), in some embodiments this may not be the case. Instead, computer system 100 may select a subset of those other features for inclusion in the labeled dataset (Xᵢ, yᵢ) based on one or more criteria (e.g., a correlation measure between those other features and feature fᵢ, etc.).

Yet further, various modifications to the random re-shuffling process at blocks 216-228 are possible. For example, as an alternative to re-training supervised ML model Mⱼ on new labeled dataset (Xⱼ, yᵢ)′ and providing the query data instances as input to the re-trained version of Mⱼ at blocks 222 and 224, computer system 100 can provide new labeled dataset (Xⱼ, yⱼ)′ as input to the initial trained version of Mⱼ and thus check the accuracy of that initial trained model against the randomly re-shuffled training data. In addition, rather than performing a single random re-shuffling of labeled data set (Xⱼ, yⱼ), in some embodiments computer system 100 can perform several random re-shufflings of (Xⱼ, yⱼ)—thereby generating several “second accuracy scores” per block 226—and compute the inter-feature influence score for each feature pair (fᵢ, fⱼ) based on the first accuracy score and some aggregation (e.g., average) of the second accuracy scores.

### 4. Dimensionality Reduction

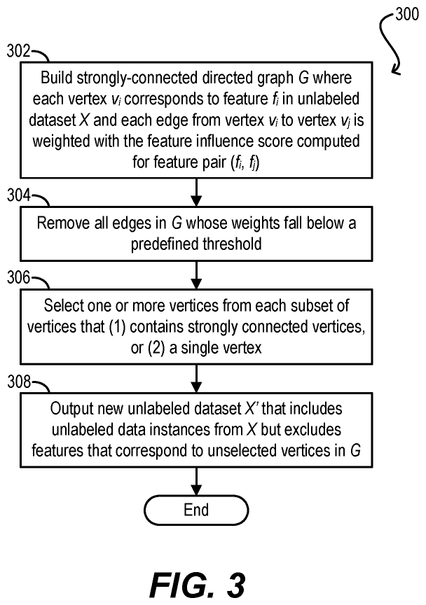

FIG. 3 depicts a flowchart 300 that may be performed by computer system 100 for reducing the number of features/dimensions in unlabeled dataset X based on the inter-feature influence scores computed for the features in X (per, e.g., flowchart 200 of FIG. 2) according to certain embodiments. The goal of this process is to compress/reduce the size of unlabeled dataset X by keeping the features that are representative of the dataset's overall data distribution while removing features that are redundant. This in turn allows unlabeled dataset X to be used, in its compressed/reduced form, for machine learning in environments that cannot efficiently handle high dimensional datasets due to various constraints (e.g., memory, compute, bandwidth, time, etc.), without significantly changing the outcome or accuracy of the learning process.

Starting with block 302, computer system 100 can build a strongly-connected directed graph G comprising vertices v₁, . . . , vₙ and edges e₁, . . . , eₙ₍ₙ₋₁₎ where (1) each vertex vᵢ corresponds to a feature fᵢ in unlabeled dataset X and (2) each edge from vertex vᵢ to vertex vⱼ is weighted with the inter-feature influence score computed for feature pair (fᵢ, fⱼ). For example, assume the following inter-feature influence scores are computed for the version of unlabeled dataset X shown in Table 1:

TABLE 5

| | Inter-Feature |
|---|---|
| | Influence |
| Feature Pair | Score |
| (age, hair color) | 0.85 |
| (age, eye color) | 0.05 |
| (hair color, age) | 0.9 |
| (hair color, eye color) | 0.1 |
| (eye color, age) | 0.08 |
| (eye color, hair color) | 0.11 |

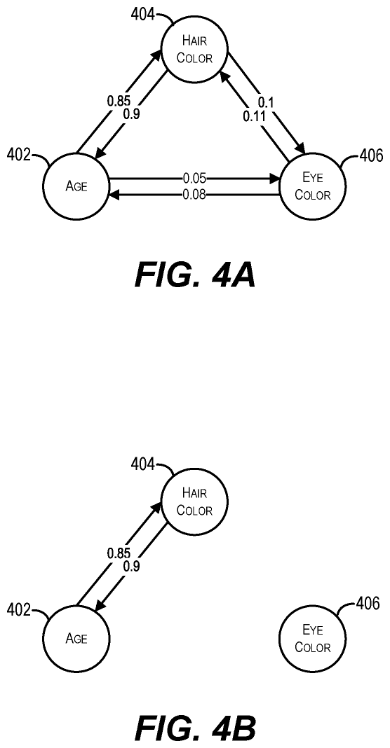

Given the scores above, FIG. 4A depicts a graph 400 that may be constructed by computer system 100 in accordance with block 302. As shown in FIG. 4A, graph 400 includes three vertices 402, 404, and 406 corresponding to the features “age,” “hair color,” and “eye color” respectively, along with edges between these vertices that are weighted in accordance with the inter-feature influence scores presented in Table 5.

At block 304, computer system 100 can remove all of the edges in graph G whose weights are below a predefined score threshold t. Through this edge removal step, the computer system can effectively isolate subsets of vertices in G—and thus, features in X—whose members have a relatively strong influence on each other. For example, FIG. 4B depicts a version of graph 400 in which all edges with a weight below threshold 0.8 are removed. As shown in FIG. 4B, the “age” and “hair color” vertices remain strongly connected to each other (indicating that these features strongly influence each other), while the “eye color” vertex is no longer connected to “age” or “hair color” (indicating that “eye color” does not strongly influence “age” or “hair color” and vice versa).

Upon removing the edges per block 304, computer system 100 can select one vertex (or x vertices, where x is less than the subset total) from each subset of one or more vertices in graph G whose members remain strongly connected (i.e., connected to each other via incoming and outgoing edges), or comprises exactly one vertex (block 306). With respect to FIG. 4B, this means that computer system 100 can select, e.g., the “age” vertex from the subset of connected vertices comprising “age” and “hair color” (because the “age” and “hair color” vertices remain strongly connected) and can select the “eye color” vertex (because “eye color” is part of a subset comprising exactly one vertex).

Finally, at block 308, computer system 100 can output a new unlabeled dataset X′ that includes all of the unlabeled data instances in unlabeled dataset X, but excludes the features that correspond to unselected vertices at block 306. Stated another way, each unlabeled data instance in new unlabeled dataset X′ can solely include feature values for the features selected at block 306. For example, if computer system 100 selects the “age” and “eye color” vertices from graph 400 in FIG. 4B, the following would be the content of new unlabeled dataset X′:

TABLE 6

| Age | Eye Color |
|---|---|
| 25 | Brown |
| 63 | Blue |
| 16 | Brown |
| 52 | Green |

### 5. Extensions

In addition to the techniques described above, in some embodiments computer system 100 may construct one or more new features for unlabeled dataset X and augment X with those new feature(s) prior to computing inter-feature influence scores. For example, in the case where X will be used to perform anomaly detection, computer system 100 may employ an unsupervised anomaly detection model to generate anomaly scores for the unlabeled data instances in X and add the anomaly scores as a new feature/column to X.

The benefit of this approach is that it will cause computer system 100 to compute inter-feature influence scores for the new feature(s), which can help in capturing the importance of certain existing features in X that generally have a low influence on other existing features, but have high value for the purpose(s) reflected in the new feature(s) (e.g., anomaly detection). For example, a given feature fₖ may have low inter-feature influence scores with respect to other existing features in X, but may have a high inter-feature influence score with respect to a newly added anomaly score feature fₐ, thereby making clear that feature fₖ is important for anomaly detection.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any data storage device that can store data which can thereafter be input to a computer system. The non-transitory computer readable media may be based on any existing or subsequently developed technology for embodying computer programs in a manner that enables them to be read by a computer system. Examples of non-transitory computer readable media include a hard drive, network attached storage (NAS), read-only memory, random-access memory, flash-based nonvolatile memory (e.g., a flash memory card or a solid state disk), a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments, and are presented to illustrate the flexibility and advantages of particular embodiments as defined by the following claims. Other arrangements, embodiments, implementations and equivalents can be employed without departing from the scope hereof as defined by the claims.

What is claimed is:

1. A method comprising:
receiving, by a computer system, an unlabeled dataset comprising a plurality of unlabeled data instances, each unlabeled data instance including values for a plurality of features;
for each feature in the plurality of features, training, by the computer system, a supervised machine learning (ML) model on a labeled dataset derived from the unlabeled dataset, wherein the labeled dataset comprises a plurality of labeled data instances, and wherein each labeled data instance includes:
a label corresponding to a value for the feature in an unlabeled data instance of the unlabeled dataset; and
values for other features in the unlabeled data instance; and
for each pair of first and second features in the plurality of features, computing, by the computer system, an inter-feature influence score using the trained supervised ML model for the second feature, the inter-feature influence score indicating how useful the first feature is in predicting the second feature.

2. The method of claim 1 wherein computing the inter-feature influence score comprises:
determining a first accuracy score for the trained supervised ML model for the second feature; and
randomly re-shuffling values of the first feature in the labeled dataset for the second feature, resulting in a new labeled dataset for the second feature.

3. The method of claim 2 wherein computing the inter-feature influence score further comprises:
re-training the supervised ML model for the second feature on the new labeled dataset;
determining a second accuracy score for the re-trained supervised ML model; and
computing the inter-feature influence score based on the first and second accuracy scores.

4. The method of claim 3 wherein the inter-feature influence score is proportional to a degree of divergence between the first and second accuracy scores.

5. The method of claim 1 further comprising:
performing dimensionality reduction on the unlabeled dataset based on the inter-feature influence scores.

6. The method of claim 5 wherein performing dimensionality reduction on the unlabeled dataset comprises:
building a graph comprising a plurality of vertices and a plurality of edges, each vertex corresponding to a feature in the plurality of features, each edge between a pair of vertices being weighted with the inter-feature influence score computed for the pair of features corresponding to the pair of vertices; and
removing all edges in the graph whose weights are below a predefined threshold.

7. The method of claim 6 wherein performing dimensionality reduction on the unlabeled dataset further comprises, subsequently to the removing:
selecting one or more vertices in the graph from each subset of vertices that remain strongly connected; and
outputting a new unlabeled dataset that includes the plurality of unlabeled data instances but excludes features corresponding to unselected vertices in the graph.

8. A non-transitory computer readable storage medium having stored thereon program code executable by a computer system, the program code causing the computer system to execute a method comprising:
receiving an unlabeled dataset comprising a plurality of unlabeled data instances, each unlabeled data instance including values for a plurality of features;
for each feature in the plurality of features, training a supervised machine learning (ML) model on a labeled dataset derived from the unlabeled dataset, wherein the labeled dataset comprises a plurality of labeled data instances, and wherein each labeled data instance includes:
a label corresponding to a value for the feature in an unlabeled data instance of the unlabeled dataset; and
values for other features in the unlabeled data instance; and
for each pair of first and second features in the plurality of features, computing an inter-feature influence score using the trained supervised ML model for the second feature, the inter-feature influence score indicating how useful the first feature is in predicting the second feature.

9. The non-transitory computer readable storage medium of claim 8 wherein computing the inter-feature influence score comprises:
determining a first accuracy score for the trained supervised ML model for the second feature; and
randomly re-shuffling values of the first feature in the labeled dataset for the second feature, resulting in a new labeled dataset for the second feature.

10. The non-transitory computer readable storage medium of claim 9 wherein computing the inter-feature influence score further comprises:
re-training the supervised ML model for the second feature on the new labeled dataset;
determining a second accuracy score for the re-trained supervised ML model; and
computing the inter-feature influence score based on the first and second accuracy scores.

11. The non-transitory computer readable storage medium of claim 10 wherein the inter-feature influence score is proportional to a degree of divergence between the first and second accuracy scores.

12. The non-transitory computer readable storage medium of claim 8 wherein the method further comprises:
performing dimensionality reduction on the unlabeled dataset based on the inter-feature influence scores.

13. The non-transitory computer readable storage medium of claim 12 wherein performing dimensionality reduction on the unlabeled dataset comprises:
building a graph comprising a plurality of vertices and a plurality of edges, each vertex corresponding to a feature in the plurality of features, each edge between a pair of vertices being weighted with the inter-feature influence score computed for the pair of features corresponding to the pair of vertices; and
removing all edges in the graph whose weights are below a predefined threshold.

14. The non-transitory computer readable storage medium of claim 13 wherein performing dimensionality reduction on the unlabeled dataset further comprises, subsequently to the removing:
selecting one or more vertices in the graph from each subset of vertices that remain strongly connected; and
outputting a new unlabeled dataset that includes the plurality of unlabeled data instances but excludes features corresponding to unselected vertices in the graph.

15. A computer system comprising:
a processor; and
a non-transitory computer readable medium having stored thereon program code that, when executed, causes the processor to:
receive an unlabeled dataset comprising a plurality of unlabeled data instances, each unlabeled data instance including values for a plurality of features;
for each feature in the plurality of features, train a supervised machine learning (ML) model on a labeled dataset derived from the unlabeled dataset, wherein the labeled dataset comprises a plurality of labeled data instances, and wherein each labeled data instance includes:
a label corresponding to a value for the feature in an unlabeled data instance of the unlabeled dataset; and
values for other features in the unlabeled data instance; and
for each pair of first and second features in the plurality of features, compute an inter-feature influence score using the trained supervised ML model for the second feature, the inter-feature influence score indicating how useful the first feature is in predicting the second feature.

16. The computer system of claim 15 wherein the program code that causes the processor to compute the inter-feature influence score comprises program code that causes the processor to:
determine a first accuracy score for the trained supervised ML model for the second feature; and
randomly re-shuffle values of the first feature in the labeled dataset for the second feature, resulting in a new labeled dataset for the second feature.

17. The computer system of claim 16 wherein the program code that causes the processor to compute the inter-feature influence score further comprises program code that causes the processor to:
re-train the supervised ML model for the second feature on the new labeled dataset;
determine a second accuracy score for the re-trained supervised ML model; and
compute the inter-feature influence score based on the first and second accuracy scores.

18. The computer system of claim 17 wherein the inter-feature influence score is proportional to a degree of divergence between the first and second accuracy scores.

19. The computer system of claim 15 wherein the program code further causes the processor to:
perform dimensionality reduction on the unlabeled dataset based on the inter-feature influence scores.

20. The computer system of claim 19 wherein the program code that causes the processor to perform dimensionality reduction on the unlabeled dataset comprises program code that causes the processor to:
build a graph comprising a plurality of vertices and a plurality of edges, each vertex corresponding to a feature in the plurality of features, each edge between a pair of vertices being weighted with the inter-feature influence score computed for the pair of features corresponding to the pair of vertices; and
remove all edges in the graph whose weights are below a predefined threshold.

21. The computer system of claim 20 wherein the program code that causes the processor to perform dimensionality reduction on the unlabeled dataset further comprises program code that causes the processor to, subsequently to the removing:
select one or more vertices in the graph from each subset of vertices that remain strongly connected; and
output a new unlabeled dataset that includes the plurality of unlabeled data instances but excludes features corresponding to unselected vertices in the graph.
